(19) United States
(12) Patent Application Publication
(10) Pub. No.: US 2017/0317408 A1
(43) Pub. Date: Nov. 2, 2017

(54) ROOF MODULE

(71) Applicant: Yazaki Corporation, Tokyo (JP)

(72) Inventors: Ryo Hamada, Shizuoka (JP); Akira Norizuki, Shizuoka (JP); Kunihiko Yamada, Shizuoka (JP); Yoshikazu Nagashima, Shizuoka (JP); Goro Nakamura, Shizuoka (JP)

(21) Appl. No.: 15/489,429

(22) Filed: Apr. 17, 2017

(30) Foreign Application Priority Data
Apr. 28, 2016 (JP) 2016-090267

(51) Int. Cl. H01Q 1/32; B62D 25/06; B60R 13/02

(52) U.S. Cl. CPC H01Q 1/3275; B60R 13/0212; B62D 25/06

(57) ABSTRACT

A roof module includes an antenna that is provided in a planar shape along a roof panel on a cabin inner side of the roof panel and transmits and receives electromagnetic waves. The roof panel is formed of a resin material in a planer shape and defines an exterior of a vehicle. The roof module also includes a metal panel that is formed of a metal material in a planar shape and provided along the antenna on the cabin inner side of the antenna. In this manner, the roof module can stabilize electromagnetic environments by the metal panel intentionally provided on the cabin inner side of the antenna in the vehicle the roof panel of which is formed of a non-metal material but a resin material.

### CROSS-REFERENCE TO RELATED APPLICATION(S)

The present application claims priority to and incorporates by reference the entire contents of Japanese Patent Application No. 2016-090267 filed in Japan on Apr. 28, 2016.

### BACKGROUND OF THE INVENTION

### 1. Field of the Invention

The present invention relates to a roof module.

### 2. Description of the Related Art

As a conventional roof module applied to vehicles, for example, Japanese Patent Application Laid-open No. 2009-171019 discloses an overhead module attached to a cabin ceiling surface. This overhead module houses an antenna for on-vehicle wireless device in which a part or the entirety of the antenna is disposed in a radio wave transmission and reception area.

The above-described overhead module in Japanese Patent Application Laid-open No. 2009-171019 has a margin for improvement in aspects of various communication environments, for example.

### SUMMARY OF THE INVENTION

In view of the above-described aspects, the present invention aims at providing a roof module capable of securing appropriate communication environments.

In order to achieve the above mentioned object, a roof module according to one aspect of the present invention includes an antenna that is provided in a planar shape along a roof panel on a cabin inner side of the roof panel and transmits and receives electromagnetic waves, the roof panel being formed of a resin material in a planer shape and defining an exterior of a vehicle; and a metal panel that is formed of a metal material in a planar shape and provided along the antenna on the cabin inner side of the antenna.

According to another aspect of the present invention, in the roof module, it is possible to further include a module substrate that is provided in a planar shape along the metal panel on the cabin inner side of the metal panel and includes an electronic part mounted thereon to perform communication inside the cabin.

According to still another aspect of the present invention, in the roof module, it is possible to further include a housing that houses the antenna and the metal panel and includes an attachment portion to a cabin inner side surface of the roof panel.

According to still another aspect of the present invention, in the roof module, it is possible to configure that the antenna is provided in contact with the roof panel.

According to still another aspect of the present invention, in the roof module, it is possible to configure that the metal material contains at least one of copper, aluminum, and iron.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic partial perspective view explaining an overview of a roof module according to an embodiment;

FIG. 2 is a schematic view explaining an overview of the roof module according to the embodiment;

FIG. 3 is an exploded perspective view illustrating a schematic configuration of the roof module according to the embodiment;

FIG. 4 is an exploded perspective view illustrating a schematic configuration of the roof module according to the embodiment;

FIG. 5 is a schematic partial sectional view illustrating a schematic configuration of the roof module according to the embodiment; and

FIG. 6 is a schematic partial sectional view illustrating a schematic configuration of the roof module according to a modification.

### DETAILED DESCRIPTION OF THE PREFERRED EMBODIMENTS

The following will describe in detail an embodiment of the invention with reference to the enclosed drawings. Note that the embodiment does not limit the invention. Additionally, components in the following embodiment include components that can be easily substituted by a person skilled in the art, or substantially the same components.

### Embodiment

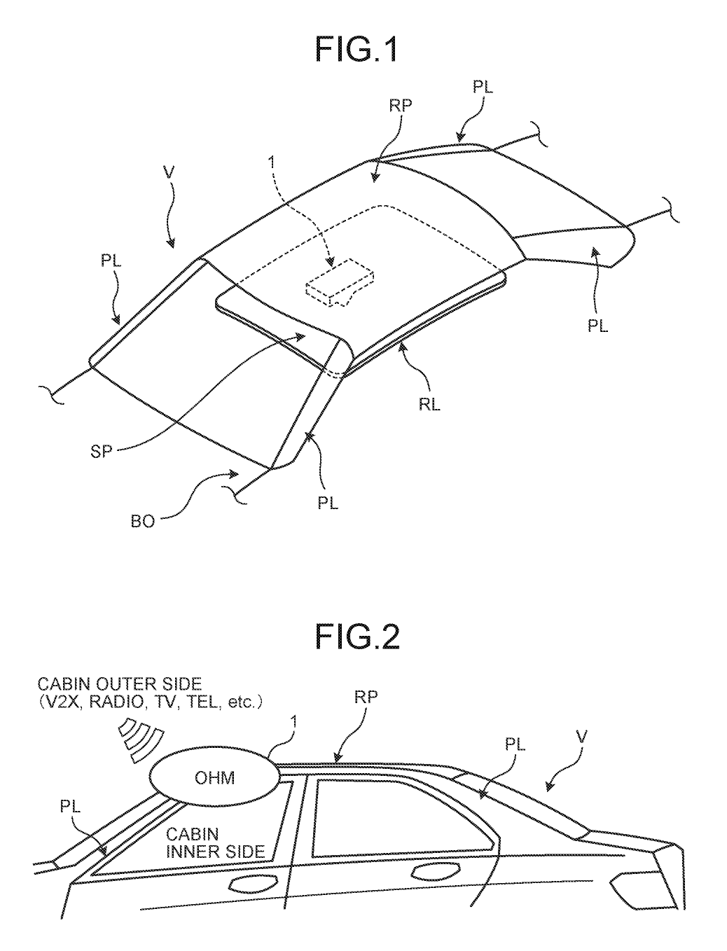

A roof module 1 according to the embodiment illustrated in FIG. 1 and FIG. 2 is an on-vehicle module that is applied to a vehicle V and forms a part of a wire harness connecting devices on the vehicle V for power supply or signal communication. The roof module 1 is provided in the vicinity of a roof panel RP that is a roof member defining the exterior of the vehicle V. The roof module 1 is an integrated overhead module integrating various functions to secure appropriate communication environments. The roof module 1 according to the embodiment typically aims at securing appropriate communication environments inside and outside the vehicle and, for example, receives “vehicle to everything” (V2X) communication including “vehicle to vehicle” (V2V: between vehicles) communication and “vehicle to infrastructure” (V2I: between a road and a vehicle), and communication from the outside of the cabin such as a radio, a digital television (DTV), and a telephone (TEL), gathers information, and transfers the gathered information to the inside of the cabin to link communication outside the cabin and communication inside the cabin in real time.

Here, the roof panel RP in which the roof module 1 according to the embodiment is provided forms the exterior of the vehicle V, as described above, and is an outer surface member arranged on the most outer side on the vertically upper side in the vehicle V. Here, the roof panel RP has a slightly curved board shape to project to the cabin outer side. The roof panel RP is connected to a vehicle main body BO through a plurality of hollow columnar pillars PL and supported on the vertically upper side of the vehicle main body BO. The vehicle V is regionally divided into the cabin outer side and the cabin inner side with the roof panel RP that is the outer surface member as a boundary on the vertically upper side. The roof module 1 is disposed in housing space SP defined between the roof panel RP and a roof liner RL provided on the cabin inner side of the roof panel RP. The roof liner RL is an interior member forming the design surface inside the cabin, and is also referred to as a trim.

The roof panel RP according to the embodiment is a planar resin panel of a resin material, and is formed of, for example, a resin material with relatively high rigidity. That is, the roof module 1 according to the embodiment is applied to the roof panel RP of the vehicle V the resin roof panel RP of which defines a part of the exterior.

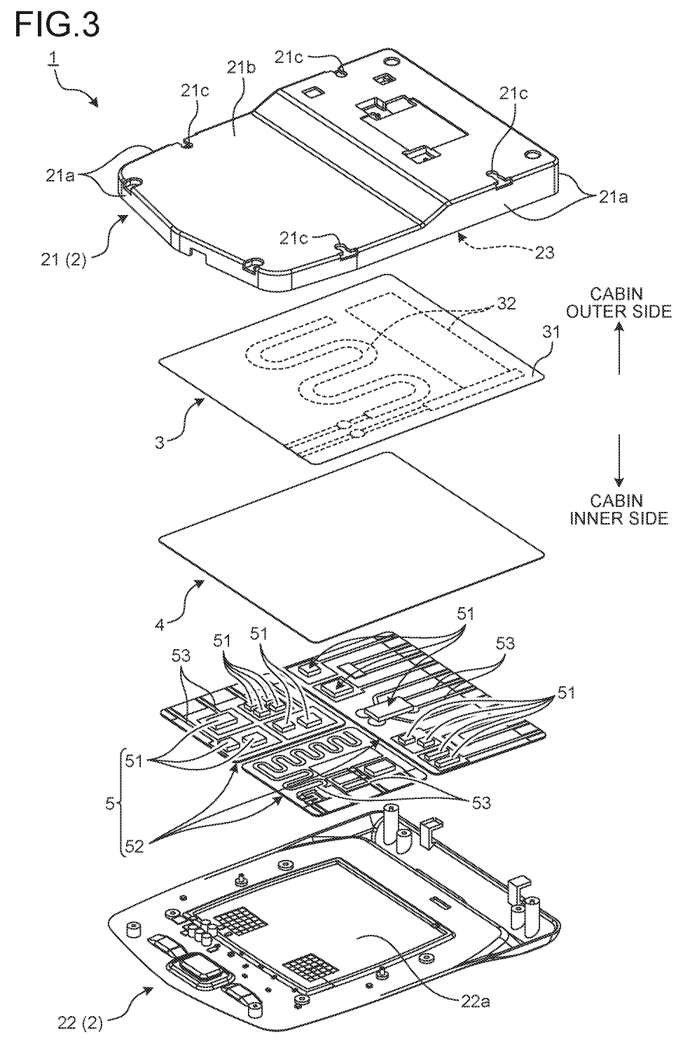

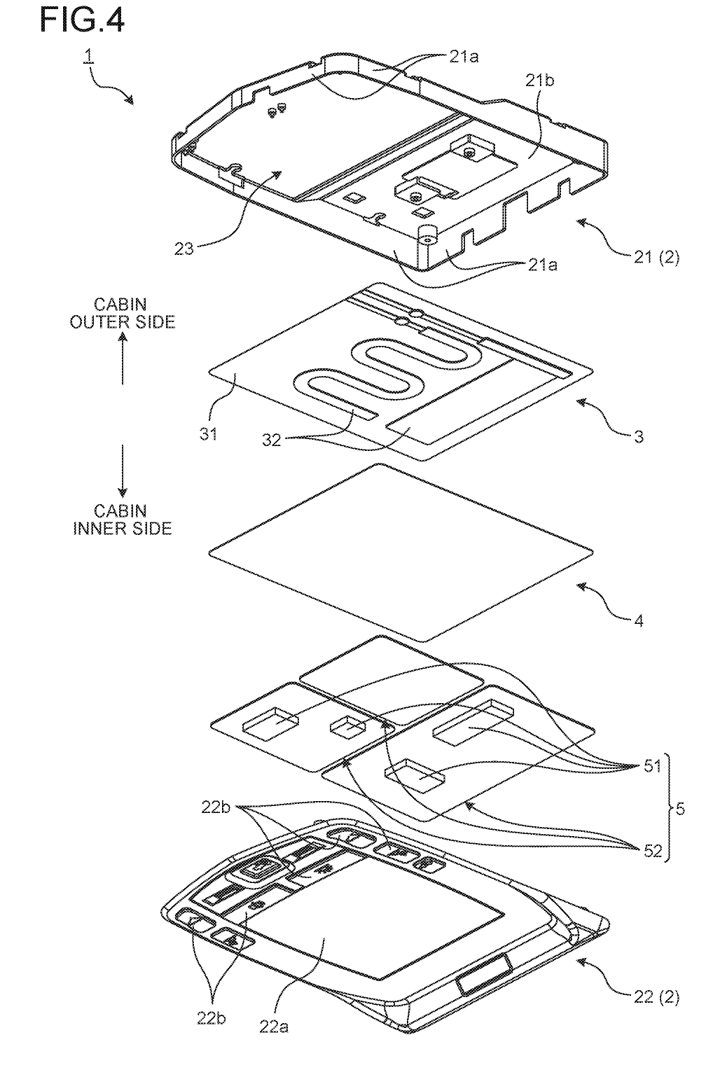

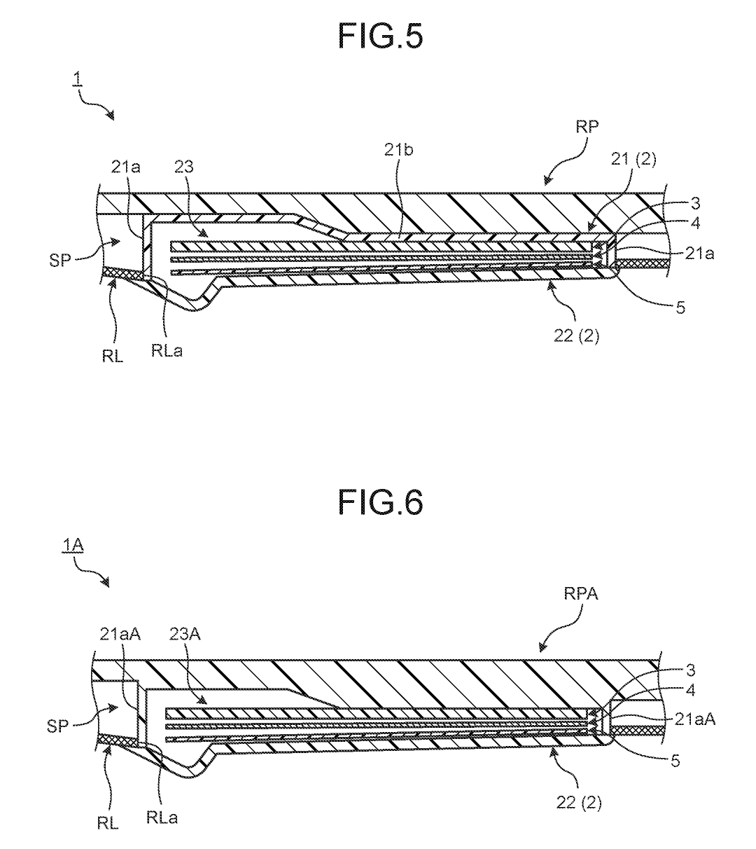

The following will describe components of the roof module 1 in detail with reference to FIG. 3, FIG. 4, and FIG. 5. In the following, each part will be described in the positional relation in the state where the roof module 1 is assembled in the vehicle V, otherwise specified.

To be more specific, the roof module 1 includes a housing 2, an antenna 3, a metal panel 4, and a module substrate 5, as illustrated in FIG. 3, FIG. 4, and FIG. 5, these components being integrated and modularized. The housing 2 includes a base 21 and a cover 22. The roof module 1 has, on the cabin inner side of the roof panel RP, a structure in which the base 21, the antenna 3, the metal panel 4, the module substrate 5, and the cover 22 are laminated in this order from the cabin outer side to the cabin inner side. In the roof module 1, the antenna 3, the module substrate 5, and the like are connected electrically to a power source through a power line (wire) and the like arranged in the housing space SP, the inner space of the hollow cylindrical pillars PL, and the like, so as to supply the roof module 1 with electric power. Similarly, in the roof module 1, the antenna 3, the module substrate 5, and the like are connected electrically to a part of equipment of other on-vehicle modules forming the wire harness through a communication line (wire) arranged in the housing space SP, the inner space of the hollow cylindrical pillars PL, and the like, so as to allow the roof module 1 to perform mutual communication.

The laminating direction of the components is typically along the substantially vertical direction in the state where the roof module 1 is mounted on the vehicle V. However, depending on the arrangement state of the roof module 1, the laminating direction may have a given angle relative to the vertical direction. The roof module 1 may be modularized including the roof panel RP itself, or modularized without including the roof panel RP. When the roof module 1 includes the roof panel RP, it has a structure in which the roof panel RP, the base 21, the antenna 3, the metal panel 4, the module substrate 5, and the cover 22 are laminated in this order from the cabin outer side to the cabin inner side.

The housing 2 houses the parts of the roof module 1, and houses here at least the antenna 3, the metal panel 4, and the module substrate 5. As described above, the housing 2 includes the base 21 and the cover 22, and has a hollow box shape as a whole in combination of the base 21 and the cover 22. The base 21 and the cover 22 are formed of insulating synthetic resin. Furthermore, the base 21 and the cover 22 are preferably formed of synthetic resin excellent in heat dissipation and heat shielding property that is appropriate for environments of the roof panel RP.

The base 21 is a main part forming the housing 2. The base 21 is a plate-shaped (tray-shaped) member. The base 21 includes a side wall part 21a that is a frame-shaped wall forming housing space 23, and a bottom part 21b that is a bottom body closing one opening (opening on the cabin outer side) of the housing space 23 surrounded by the side wall part 21a, these parts being formed integrally. The bottom part 21b has a substantially rectangular plate shape, and the side wall part 21a is formed to be erect toward the cabin inner side from the edge of the bottom part 21b. The base 21 is formed in combination of the side wall part 21a and the bottom part 21b, and has as a whole a hollow box shape with an opening on the cabin inner side.

Moreover, the base 21 includes attaching parts 21c to a cabin inner side surface of the roof panel RP, on a cabin outer side surface of the bottom part 21b, that is, a surface facing the roof panel RP. A plurality of attaching parts 21c are provided on the edge of the bottom part 21b, and four attaching parts 21c are provided in this embodiment. Here, each attaching part 21c is recessed and locked to a locking projection provided on the roof panel RP. In this manner, the base 21 is attached to the cabin inner side surface of the roof panel RP. The base 21 is provided on the cabin inner side of the roof panel RP along the roof panel RP through the attaching parts 21c.

The cover 22 is laminated on the cabin inner side of the base 21 and assembled mutually to form the housing 2 together with the base 21. The cover 22 is a lid-shaped cover member closing the opening on the cabin inner side of the base 21, and has a substantially rectangular plate shape. The cover 22 is partially formed of a light transmitting member 22a transmitting light. The cover 22 includes operators 22b such as a button and a switch for operating a part of operations of electronic parts 51 described later.

The base 21 and the cover 22 are mutually assembled through various locking structures, bolt fastening members, and the like, in the positional relation in which the bottom part 21b of the base 21 is positioned on the cabin outer side and the cover 22 is positioned on the cabin inner side. These components form the substantially box-shaped housing 2 as a whole. The housing 2 includes, as the housing space 23, hollow inner space defined by the base 21 and the cover 22 in the state where the base 21 and the cover 22 are assembled. The housing space 23 is space for housing the antenna 3, the metal panel 4, and the module substrate 5.

The antenna 3 is provided in a planar shape along the roof panel RP on the cabin inner side of the roof panel RP, and transmits and receives electromagnetic waves such as radio waves to perform communication with communication devices outside the cabin. The antenna 3 communicates with communication devices outside the cabin using wide area wireless communication standards V2X, radio (AM, FM, etc.), DTV (2K, 4K, 8K, etc.), TEL (PCS, CDMA, LTE, WiMAX (registered trademark), 5 G, etc.), global navigation satellite systems (GNSS) (GPS, GLONASS, Galileo, etc.), and the like. Moreover, the antenna 3 may communicate with communication devices outside the cabin using narrow area wireless communication standards ETC/DSRC, VICS (registered trademark), wireless LAN, millimeter wave communication, and the like. The antenna 3 according to the embodiment is what is called a planar antenna, and is typically a substantially rectangular plate-shaped thin antenna housed in the housing space SP formed between the roof panel RP and the roof liner RL. The antenna 3 includes, for example, a circuit body 32 printed as a printing circuit body forming an antenna pattern on a surface of an insulation substrate 31 (a cabin inner side surface here without limiting thereto). Alternatively, the antenna 3 may be formed by a micro strip antenna, and the like, including a dielectric substrate and a radiating element and a ground conductor plate printed and wired on both sides of the dielectric substrate. Here, the antenna 3 is fixed to the cabin inner side surface of the base 21 through various fixing mechanisms, and is provided in a planar shape along the base 21.

The metal panel 4 is formed of a metal material in a planar shape, and provided on the cabin inner side of the antenna 3 along the antenna 3. That is, the metal panel 4 is provided on the opposite side to the roof panel RP with the antenna 3 interposed therebetween. The metal panel 4 is formed in a substantially rectangular plate shape to cover substantially the entirety of the cabin inner side surface of the antenna 3. The metal panel 4 according to the embodiment is formed intentionally by a metal material on the cabin inner side of the roof panel RP of the cabin V in which the roof panel RP is formed of a non-metal material but a resin material so as to stabilize electromagnetic wave (radio wave) environments.

The metal panel 4 has the following function, for example, as a function of stabilizing electromagnetic wave environments. That is, the metal panel 4 functions, for example, as a boundary between communication environments outside the cabin and communication environments inside the cabin in the vehicle V the roof panel RP of which is formed of a non-metal material but a resin material. The communication environments outside the cabin here typically correspond to communication environments by the antenna 3 positioned on the cabin outer side of the metal panel 4. Meanwhile, the communication environments inside the cabin typically correspond to communication environments by the electronic parts 51 and the like mounted on the module substrate 5 described later that is positioned on the cabin inner side of the metal panel 4. The metal panel 4 also functions as a shielding plate (shielding member) suppressing mutual noises between the communication environments outside the cabin and communication environments inside the cabin. Here, the metal panel 4 is positioned between the above-described antenna 3 and the module substrate 5 described later, and thus can function as a shielding plate for both sides. Moreover, the metal panel 4 functions as a ground plane of the above-described antenna 3 positioned on the cabin outer side of the metal panel 4. The metal panel 4 also functions as a heat shielding plate suppressing mutual heat transmission between the above described antenna 3 and the module substrate 5 describe later while promoting heat dissipation. Furthermore, the metal panel 4 functions as a part adjusting directivity of wireless communication by the electronic part 51 and the like mounted on the module substrate 5 described later that is positioned on the cabin inner side of the metal panel 4. In addition, the metal panel 4 functions also as a reinforcing member (core member) for reinforcing the rigidity of the above-described antenna 3 and the module substrate 5 described later. The metal panel 4 according to the embodiment is formed as a composite function member integrating the above-described various functions.

The metal panel 4 is preferably formed of a metal material relatively high in conductivity (in other words, a metal material relatively low in volume resistivity) when, for example, the shielding effect of an electric field is considered to be important. Then, it is preferable that the metal panel 4 be typically formed of silver, copper, aluminum, and the like. The metal panel 4 is preferably formed of a metal material relatively high in initial magnetic permeability when, for example, the shielding effect of a magnetic field is considered to be important. Then, it is preferable that the metal panel 4 be typically formed of a permalloy, iron, nickel, and the like. The metal panel 4 is preferably formed of materials containing at least one of copper, aluminum, and iron while considering the above-described aspects, cost effectiveness, and workability. In this case, the metal panel 4 may be formed as a pure metal plate of a single metal element of copper, aluminum, or iron, or an alloy sheet containing such metal elements, e.g., a brass plate that is an alloy containing an element, such as zinc, added to copper, a copper plate that is an alloy containing an element such as carbon, chromium, and nickel added to iron, a stainless plate, and the like. Here, the metal material forming the metal panel 4 is fixed to the cabin inner side surface of the antenna 3 or the base 21 of the housing 2 through various fixing mechanisms, and provided in a planar shape along the antenna 3.

The module substrate 5 is provided in a planar form along the metal panel 4 on the cabin inner side of the metal panel 4, and includes the electronic parts 51 mounted thereon. That is, the module substrate 5 is provided on the opposite side to the antenna 3 with the metal panel 4 interposed therebetween. The module substrate 5 includes a plurality of electronic parts 51 and a plurality of substrates 52 on which the electronic parts 51 are mounted, and three substrates 52 are provided in this example.

The electronic parts 51 mounted on the substrates 52 are various elements to exert various functions, and include various functional parts. The electronic parts 51 include, for example, lightning functional parts illuminating the cabin inner side, communication functional parts performing communication inside the cabin, and the like. The lightning functional parts include, for example, a light source such as a light emitting diode (LED) element irradiating light. The communication functional parts gather information acquired through the antenna 3 and transfer the gathered information to the inside of the cabin to link the cabin outer side and the cabin inner side in real time. The communication functional parts include, for example, information processing functional parts performing various kinds of processing on information transmitted and received by the antenna 3, relay functional parts mutually connecting and relaying various networks in the cabin, wireless communication functional parts performing wireless communication inside the cabin, control functional parts controlling communication inside the cabin, and the like. The information processing functional parts are, for example, a tuner forming a tuner circuit, and the like. The relay functional parts include router functional parts distributing information between networks, gateway (G/W) functional parts converting protocols between networks using different protocols and relaying the networks, and the like. The wireless communication functional parts include, for example, transmission and reception units in various forms such as small distance wireless communication (NFC) of W-LAN, Wifi (registered trademark), and Bluetooth (registered trademark). In the wireless communication functional parts, the directivity of wireless communication is adjusted by adjusting the shape, the size, and the like of the metal panel 4. The control functional parts include an electronic control unit with a microcomputer, an electronic control unit (ECU), and the like.

The substrate 52 includes the electronic part 51 mounted thereon, and has a substantially rectangular plate shape. The three substrates 52 cover substantially the entirety of the cabin inner side surface of the antenna 3. As the substrate 52, there can be used what is called a printed circuit board (PCB) that is formed of an insulating resin material, such as epoxy resin, glass epoxy resin, paper epoxy resin, and ceramic, and has thereon, as a printing circuit body, a wire pattern (print pattern) as a circuit body 53 formed of a conductive material such as copper. The circuit body 53 electrically connects a plurality of electronic parts 51 and forms a circuit in accordance with a required function. The electronic parts 51 are mounted on the circuit body 53 through through-holes and the like. The surface of the substrate 52 forms a mounting surface, and the electronic parts 51 are mounted on the mounting surface. On the substrate 52 according to the embodiment, both surfaces on the cabin outer side and the cabin inner side are formed as mounting surfaces. However, the embodiment is not limited thereto. In the module substrate 5, the circuit body 53 of the substrate 52 may bypass the metal panel 4 or partially penetrate through the metal panel 4 to be connected electrically with the above-described antenna 3. In this manner, it is possible to mutually transmit various kinds of information transmitted and received by the antenna 3. Note that the substrate 52 may be multilayered with a plurality of insulating layers, the circuit body 53 being printed on each insulating layer (that is, a multilayered substrate). Alternatively, for example, a bus bar plate in which a bus bar as a circuit body formed of a conductive metal material may be covered by an insulating resin material to be a substrate. Here, the module substrate 5 is fixed to the cabin inner side surface of the metal panel 4 or the base 21 of the housing 2 through various fixing mechanisms, and provided in a planar shape along the metal panel 4. Then, the above-described cover 22 of the housing 2 is provided in a planar shape on the cabin inner side of the module substrate 5 along the module substrate 5. That is, the cover 22 is provided on the opposite side to the metal panel 4 with the module substrate 5 interposed therebetween.

For example, in the roof module 1 formed in the above-described manner, the antenna 3, the metal panel 4, the module substrate 5 are laminated in the order from the cabin outer side to the cabin inner side and disposed in the housing space 23 of the base 21 of the housing 2, and the cover 22 of the housing 2 is assembled to the base 21 from the cabin inner side of the module substrate 5, whereby these components are integrated. Then, the attaching parts 21c of the base 21 are locked to the locking projections provided on the roof panel RP in the state where the components are integrated, whereby the roof module 1 is attached to the cabin inner side surface of the roof panel RP and housed in the housing space SP between the roof panel RP and the roof liner RL. In the roof module 1, a part of the cover 22 including the light transmitting member 22a and the operators 22b is exposed on an opening RLa formed on the roof liner RL (see FIG. 5). Thus, it is possible, through the light transmitting member 22a, to transmit light emitted by the lightning functional parts of the electronic parts 51 to the cabin inner side to light the cabin inner side, and receive operation to the operators 22b. Then, the roof module 1 receives communication from the cabin outer side by the antenna 3, gathers information acquired in the communication, and transfers the gathered information to the inside of the cabin by the module substrate 5 to link communication outside the cabin with communication inside the cabin in real time.

The roof module 1 described above includes the antenna 3 that is formed in a planar shape along the roof panel RP on the cabin inner side of the roof panel RP and transmits and receives electromagnetic waves. The roof panel RP is formed of a resin material in a planer shape and defines the exterior of the vehicle V. The roof module 1 also includes the metal panel 4 that is formed of a metal material in a planar shape along the antenna 3 on the cabin inner side of the antenna 3.

Therefore, in the roof module 1, the roof panel RP defining the exterior of the vehicle V, the antenna 3 formed in a planar shape, and the metal panel 4 formed in a planar shape are laminated in the order from the cabin outer side to the cabin inner side. Thus, for example, the roof module 1 can be thinned to have a compact and space-saving structure. With this structure, the roof module 1 is allowed to be housed in limited space on the cabin inner side of the roof panel RP even when the roof panel RP itself is reduced in height or the housing space SP is reduced in size. Therefore, for example, there is no need to attach an antenna on front glass, rear glass, and the like, and thus the roof module 1 contributes to improve the visibility of a driver. Moreover, there is no need to provide a protrusion such as a shark-fin antenna on the cabin outer side of the roof panel RP, and thus the roof module 1 can suppress air resistance and the like of the vehicle V and contribute to fuel-saving. Then, the roof module 1 can appropriately transmit and receive electromagnetic waves to and from the cabin outer side by the antenna 3 positioned on the cabin inner side of the resin roof panel RP, and stabilize electromagnetic environments by the metal panel 4 positioned on the cabin inner side of the antenna 3. As a result, the roof module 1 can secure appropriate communication environments and preferably secure the quality of communication with the cabin outer side through the antenna 3.

Moreover, the roof module 1 can stabilize the electromagnetic environments by the metal panel 4 intentionally provided to the vehicle V the roof panel RP of which is formed of a non-metal material but a resin material. Thus, it is possible to appropriately mount the roof module 1 on the vehicle V and set the mounting position freely along the cabin inner side of the roof panel RP, which improve the mountability. In the roof module 1, the metal panel 4 is formed as a composite function member functioning as a boundary between communication environments outside the cabin and communication environments inside the cabin, a shielding plate suppressing mutual noises, a ground plane of the antenna 3, a heat shielding plate, a member adjusting directivity of wireless communication, a reinforcing member reinforcing the rigidity. Thus, it is possible to reduce the number of components and then secure appropriate communication environments, thereby reducing the manufacturing costs, for example.

Furthermore, the roof module 1 described above includes the module substrate 5 that is provided in a planar shape on the cabin inner side of the metal panel 4 along the metal panel 4 and has thereon the electronic parts 51 performing communication inside the cabin. Therefore, for example, the roof module 1 can concentrate the functions for communication inside the cabin at the module substrate 5 of the roof module 1, and can secure appropriate communication environments inside and outside the cabin to preferably secure the communication quality. Moreover, in the roof module 1, a part of communication by the electronic parts 51 mounted on the module substrate 5 is made wireless, so as to reduce and save the wiring quantity of communication lines (wire) arranged in the housing space SP, the inner space of the hollow columnar pillars PL, and the like. This contributes to further reduction in size of the housing space SP and the inner space of the hollow columnar pillars PL and also improves assembling performance. Furthermore, the roof module 1 forms the integrated overhead module integrating various functions in accordance with functions of the electronic parts 51 mounted on the module substrate 5, for example, and then secures appropriate communication environments.

In addition, the roof module 1 described above includes the housing 2 housing the antenna 3, the metal panel 4, and the module substrate 5 and having the attaching parts 21c to the cabin inner side surface of the roof panel RP. Therefore, the roof module 1 can be attached to the cabin inner side surface of the roof panel RP through the attaching parts 21c in the state where the antenna 3, the metal panel 4, and the module substrate 5 are housed in the housing 2 and unitized. Thus, it is possible to reduce workload related to assembling to the vehicle V and improve the efficiency of assembly, which improves assembling performance to the vehicle V.

Furthermore, in the roof module 1 described above, the metal material forming the metal panel 4 includes at least one of copper, aluminum, and iron. Therefore, the roof module 1 can preferably secure the shielding effect of an electric field or a magnetic field and then secure easy processing, which reduces the manufacturing costs.

Note that the roof module according to the above-described embodiment of the invention is not limited to the above-described embodiment, and various changes can be made without departing from claims.

In the above description, the antenna 3 is provided on the cabin inner side surface of the roof panel RP through the base 21. However, the embodiment is not limited thereto. For example, a roof module 1A according to a modification exemplified in FIG. 6 includes a roof panel RPA in which the antenna 3 is provided directly, and is modularized including the roof panel RPA. Here, when the antenna 3 is provided directly in the roof panel RPA, the roof panel RPA and the antenna 3 are provided in direct contact with each other without interposing the above-described base 21 of the housing 2 and the like therebetween. In this case, the roof panel RPA is integrally formed with a side wall part 21a A corresponding to the above-described side wall part 21a, and the cover 22 is assembled to the side wall part 21a A. Then, in the roof module 1A, the roof panel RPA and the cover 22 define housing space 23A, and the antenna 3, the metal panel 4, and the module substrate 5 are housed in the housing space 23A. The antenna 3 is provided to be in contact with the cabin inner side surface of the roof panel RPA in the housing space 23A.

Also in this case, the roof module 1A can secure appropriate communication environments. The roof module 1A includes the roof panel RPA with which the antenna 3 is in contact. Therefore, for example, the base 21 is unnecessary, and thus the number of components is reduced and appropriate communication environments are secured. Consequently, the manufacturing costs are reduced, for example. Moreover, the roof module 1A can be further thinned to have a compact and space-saving structure.

The roof module 1 or 1A described above does not need to include the housing 2 itself or the module substrate 5.

In the roof module 1 or 1A described above, the metal panel 4 is provided between the antenna 3 and the module substrate 5. However, the embodiment is not limited thereto as long as the metal panel 4 is provided closer to the cabin inner side than the antenna 3 is. For example, the metal panel 4 may be provided on the cabin inner side of the module substrate 5.

In the roof module 1 or 1A described above, the part of the cover 22 including the light transmitting member 22a and the operators 22b is exposed on the opening RLa formed on the roof liner RL (see FIG. 5). However, the embodiment is not limited thereto, and all parts may be housed in the housing space 23, 23A, that is, no parts may be exposed on the roof liner RL.

In the roof module 1 or 1A described above, the antenna 3, the module substrate 5, and the like are connected electrically with a power source through a power line and the like arranged in the housing space SP, the inner space of the hollow columnar pillars PL, and the like to supply the roof module 1 or 1A with electric power. However, the embodiment is not limited thereto. For example, electric power may be supplied from a solar panel or the like provided on the roof panel RP or RPA with a power system independent of other on-vehicle modules. In this case, the roof module 1 or 1A can contribute to further reduction in size of the housing space SP and the inner space of the hollow columnar pillars PL.

Moreover, the metal panel 4 described above is formed as a composite function member integrating the above-described various functions. However, the embodiment is not limited thereto. The metal material forming the metal panel 4 includes at least one of copper, aluminum, and iron. However, the embodiment is not limited thereto.

In the roof module according to the embodiment, the roof panel defining the exterior of the vehicle, the antenna formed in a planar shape, and the metal panel formed in a planar shape are laminated in the order from the cabin outer side to the cabin inner side. Thus, it is possible to make thin the roof module and dispose the roof module in limited space on the cabin inner side of the roof panel. In addition, the roof module can appropriately perform transmission and reception of electromagnetic waves to and from the cabin outer side by the antenna positioned on the cabin inner side of the resin roof panel, and stabilize electromagnetic environments by the metal panel positioned on the cabin inner side of the antenna. As a result, the roof module can secure appropriate communication environments.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A roof module comprising:
an antenna that is provided in a planar shape along a roof panel on a cabin inner side of the roof panel and transmits and receives electromagnetic waves, the roof panel being formed of a resin material in a planer shape and defining an exterior of a vehicle; and
a metal panel that is formed of a metal material in a planar shape and provided along the antenna on the cabin inner side of the antenna.

2. The roof module according to claim 1, further comprising:
a module substrate that is provided in a planar shape along the metal panel on the cabin inner side of the metal panel and includes an electronic part mounted thereon to perform communication inside the cabin.

3. The roof module according to claim 1, further comprising:
a housing that houses the antenna and the metal panel and includes an attachment portion to a cabin inner side surface of the roof panel.

4. The roof module according to claim 2, further comprising:
a housing that houses the antenna and the metal panel and includes an attachment portion to a cabin inner side surface of the roof panel.

5. The roof module according to claim 1, wherein
the antenna is provided in contact with the roof panel.

6. The roof module according to claim 2, wherein
the antenna is provided in contact with the roof panel.

7. The roof module according to claim 1, wherein
the metal material contains at least one of copper, aluminum, and iron.

8. The roof module according to claim 2, wherein
the metal material contains at least one of copper, aluminum, and iron.

9. The roof module according to claim 3, wherein
the metal material contains at least one of copper, aluminum, and iron.

10. The roof module according to claim 5, wherein
the metal material contains at least one of copper, aluminum, and iron.
